(19) United States
(12) Patent Application Publication
(10) Pub. No.: US 2007/0299657 A1
(43) Pub. Date: Dec. 27, 2007

(54) METHOD AND APPARATUS FOR MONITORING MULTICHANNEL VOICE TRANSMISSIONS

(76) Inventors: George S. Kang, Agoura Hills, CA (US); Derek Brock, Arlington, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/425,456

(22) Filed: Jun. 21, 2006

(51) Int. Cl. G10L 11/04

(52) U.S. Cl. 704/207

(57) ABSTRACT

A method of speech processing includes receiving at least two separate, but temporally overlapping speech waveforms in real time; extracting a pitch waveform from each of the speech waveforms by segmenting the speech waveform pitch synchronously, fixing an analysis window size, and analyzing the speech waveform in real time; concatenating each pitch waveform by interpolating the pitch waveform at each pitch epoch, synthesizing a synthesis window size according to a desired speech playback speed, and generating a synthesized output pitch waveform; queuing each of the output waveforms so as to sequence each speech waveform serially one after the other such that the waveforms are mutually separated upon playback; and outputting each of the queued output waveforms to a selected playback device.

### TECHNICAL FIELD

The invention relates to the monitoring of multiple voice receptions, and more particularly, to the monitoring of multiple time-overlapped voice messages.

### BACKGROUND OF THE INVENTION

Many situations, especially in military environments, require monitoring of multiple voice communications. Often, such communications overlap in time, and a monitor or listener is subject to an acoustic mixture of competing, disparate signals. In this type of listening environment, it becomes difficult or impossible for the listener to reliably understand any of the concurrent signals. In a military or emergency responder setting, misunderstanding incoming messages can lead to operational disasters.

In one approach to this problem, competing communications are either presented in separate loudspeakers or are binaurally filtered to sound as if they are spatially separated and are then rendered with stereo headphones. This approach makes it easier for the listener to attend to an individual signal to the exclusion of the others, but it does not resolve the basic problem, in that the listener still must monitor and understand multiple, simultaneous communication signals.

Another approach is to display the text of the voice messages while listening. Problems with this include mistranslation, especially with low SNR reception, and the requirement that the listener also have to view text, sometimes from multiple and simultaneous sources.

There therefore remains a need to provide comprehensible monitoring of simultaneous voice signals.

### BRIEF SUMMARY OF THE INVENTION

According to the invention, a method of speech processing includes receiving at least two separate, but temporally overlapping speech waveforms in real time: extracting a pitch waveform from each of the speech waveforms by segmenting the speech waveform pitch synchronously, fixing an analysis window size, and analyzing the speech waveform in real time; concatenating each pitch waveform by interpolating the pitch waveform at each pitch epoch, synthesizing a synthesis window size according to a desired speech playback speed and generating a synthesized output pitch waveform; queuing each of the output waveforms so as to sequence each speech waveform serially one after the other such that the waveforms are mutually separated upon playback; and outputting each of the queued output waveforms to a selected playback device.

Also according to the invention, a multichannel voice transmission monitoring system includes a plurality of voice signal processing channels. Each channel includes a PSS analyzer for receiving the voice transmission and extracting its pitch waveform, a PSS synthesizer for receiving and speeding up the pitch waveform without substantially affecting its pitch frequency or resonant frequencies, and a priority queue, whereby overlapping received voice signals are de-overlapped and mutually separated upon playback. The voice signals are outputted to a playback device, e.g. one or more loudspeakers or headphones. In the latter case, the invention preferably includes a binaural filter in each voice signal processing channel, e.g. between the synthesizer and the priority queue.

The invention provides listeners with the ability to monitor and understand a small number of competing voice communications (two or more, but less than a practical number such as five or six) in nearly the same amount of time as the overlapping duration of the original consultant signals by speeding up each signal's rate of speech, without sacrificing intelligibility, and presenting the processed signals serially, in an arbitrarily prioritized order. Preferably, to ensure perceptual differentiation, the signal processing includes binaural filtering that makes each signal sound as if its apparent source is spatially distinct for applications using stereo headphones. Although the signal processing introduces an inherent delay, listeners are thus able to rapidly and effectively monitor multiple overlapping speech communications in critical situations, improving operational awareness, readiness, and response capabilities.

### BRIEF DESCRIPTION OF THE DRAWINGS

FIG. 1 is a graph illustrating received time-overlapped voice signals before (top) and after (bottom) application of the speech processing technique according to the invention;

FIG. 2 is a schematic block diagram of a multichannel voice reception monitoring system according to the invention:

FIG. 3 is a schematic illustration of the modification of a speech waveform according to the invention.

### DETAILED DESCRIPTION OF THE INVENTION

A previous speech processing technique, typically termed “Speech Analysis and Synthesis by Pitch-Synchronous Segmentation of the Speech Waveform”, or “PSS”, is described in U.S. Pat. No. 5.933,808, Kang et al., issued Aug. 3, 1999, incorporated herein by reference. This signal processing technique enables speech to be sped up without raising either pitch frequency or speech resonant frequencies. As a result, buffered (i.e., stored), digital speech signals can be time-scaled to be shorter by as much as 150% or more without being rendered unintelligible.

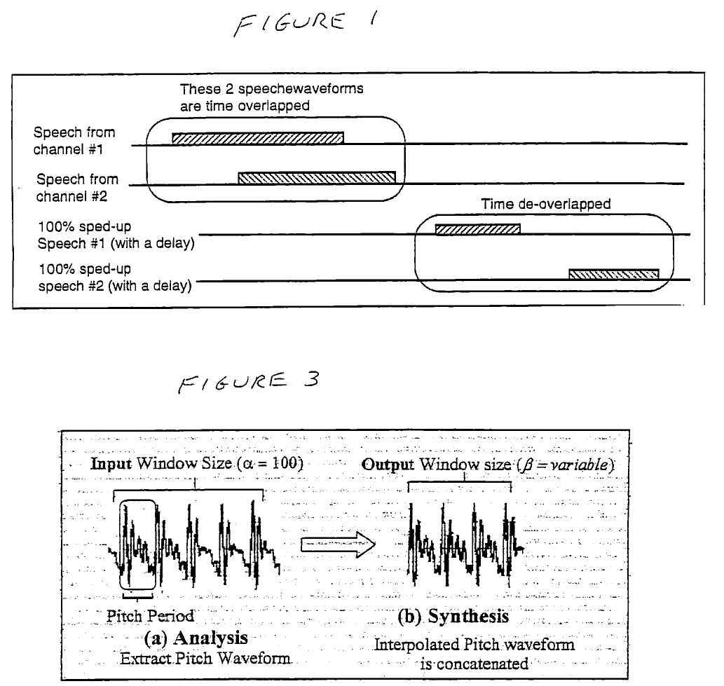

The present invention utilizes this technique, and the further introduction of a priority queue when combined with the speeding up of the multiple speech reception signals achieves serial de-overlapping of the initial time-overlapped signals, which can then be rendered in a span of time that is equivalent to the duration of the originally overlapped signals. FIG. 1 illustrates two received speech waveforms (top) that are time overlapped. The invention provides post-reception de-overlapped rendering of the two waveforms (bottom) with the introduction of a priority queue to buffer and sequence the signals and the processing necessary to speed up each waveform. This can be applied to a number of overlapping or simultaneous speech waveforms.

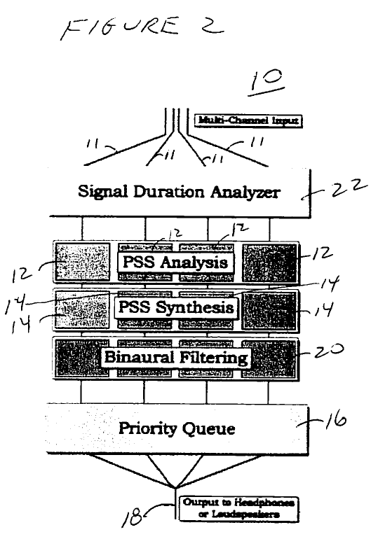

Referring now to FIG. 2, a multichannel voice reception monitoring system 10 according to the invention includes for each voice reception channel 11 a PSS analyzer 12 for receiving a voice transmission and extracting its pitch waveform, a PSS synthesizer 14 for receiving and speeding up the pitch waveform without substantially affecting its pitch frequency or resonant frequencies (described further below), and a priority queue 16 for serially scheduling the presentation of each processed voice signal on loudspeakers 18 corresponding to each channel. Although FIG. 2 illustrates a system with four voice reception channels (#1-#4) and presentation through loudspeakers 18, it should be understood that the invention also includes additional channels if desired for a particular monitoring application. Alternatively, the method of audio presentation could be through headphones substituted for or supplementing loudspeakers 18, in which case the time-scaled, PSS-processed signals would be further processed with binaural filtering using optional filter 20 that would make each signal sound as if it were coming from a spatially distinct, 3-dimensional location in a virtual listening space. System 10 also optionally includes a signal duration analyzer 22 in front of the PSS analyzer 12, so that the combined metrics then provide the degree of time-scaling (expressed as a rate percentage) desired to speed up each signal during the PSS synthesis stage. For example, if the duration of four overlapping signals is one minute and the serial duration of these signals at their original rate of speed is two minutes, to present the sped up signals in a one minute span of time, it will be necessary for each signal's PSS synthesizer to double the signal's speech rate, which is a rate increase of 100%. The invention takes advantage of the fact that voice communication channels are generally silent between transmissions and rarely operate at full capacity.

FIG. 3 illustrates how the PSS analyzer 12 extracts a pitch waveform. The speech waveform pitch is segmented synchronously and the analysis frame, or window, size alpha is fixed, e.g. at 10 ms (100 speech samples), allowing the input speech waveform to be analyzed in real time. The PSS synthesizer 14 then concatenates each pitch waveform by interpolating it at each pitch epoch, with the synthesis frame, or window, size beta varied depending on the desired speech playback speed. The output waveform must be generated in non real-time (i.e., after it has been buffered and analyzed) due to the speed change. The output window size beta in terms of speech rate change (r=0.5 means 50%) may be represented as:
No change in speech rate: beta=alpha=100 speech samples
Speech will be slowed down: beta=alphla(1+r)=100(1+r)
Speech will be sped up: beta=alpha/(1+r)=100/(1+r)

The originally overlapping speech waveforms may be serially ordered for playback by the priority queue 16 according to an arbitrarily assigned priority scheme (e.g., the onset order of the overlapping signals), a computed priority scheme (e.g., priority based on length or other statistics), a priority scheme derived from metadata (e.g., content, policy, operator assignment, etc.), or sonic combination thereof.

Obviously many modifications and variations of the present invention are possible in the light of the above teachings. It is therefore to be understood that the scope of the invention should be determined by referring to the following appended claims.

What is claimed as new and desired to be protected by Letters Patent of the United States is:

1. A method of speech processing, comprising:
receiving at least two separate, but temporally overlapping speech waveforms in real time;
extracting a pitch waveform from each of said speech waveforms by segmenting the speech waveform pitch synchronously, fixing an analysis window size, and analyzing the speech waveform in real time,
concatenating each pitch waveform by interpolating the pitch waveform at each pitch epoch, synthesizing a synthesis window size according to a desired speech playback speed and generating a synthesized output pitch waveform;
queuing each of said output waveforms to thereby sequence each speech waveform serially one after the other such that the waveforms are mutually separated upon playback; and
outputting each of said queued output waveforms to a selected playback device.

2. A method as in claim 1, wherein the playback device is a loudspeaker.

3. A method as in claim 1, wherein the analysis window size (alpha) and the synthesis window size (beta) are related according to the expression beta=alpha/(1+r)=100/(1+r) where r is a speech rate change.

4. A method as in claim 2, wherein the value of r can be determined such that the total length of time required to serially playback the output speech waveforms is equivalent or close to the length of time required to receive the original overlapping speech wave forms.

5. A method as in claim 1, wherein the synthesized speech waveforms are serially ordered for playback after being processed according to an arbitrarily assigned priority scheme, a computed priority scheme, a priority scheme derived from metadata, or a combination thereof.

6. A method as in claim 1, wherein the synthesized output speech waveforms are binaurally filtered.

7. A method as in claim 6, wherein the playback device is a headphone.

8. A method as in claim 1, further comprising applying a signal duration analysis before extracting the pitch waveform to determine a degree of time-scaling desired to speed up each speech waveform.

9. A multichannel voice transmission monitoring system, comprising:
a plurality of voice signal processing channels, wherein each said channel includes:
a PSS analyzer for receiving a voice transmission and extracting its pitch waveform:
a PSS synthesizer for receiving and speeding up the pitch waveform without substantially affecting its pitch frequency or resonant frequencies; and
a priority queue, whereby overlapping received voice signals are thereby de-overlapped and mutually separated upon playback; and
a playback device.

10. A system as in claim 9, wherein the playback device is a loudspeaker.

11. A system as in claim 9, wherein the PSS analyzer is configured for extracting a pitch waveform from each of said speech waveforms by segmenting the speech waveform pitch synchronously, fixing an analysis window size, and analyzing the speech waveform in real time, and the PSS synthesizer is configured for concatenating each pitch waveform by interpolating the pitch waveform at each pitch epoch, synthesizing a synthesis window size according to a desired speech playback speed, and generating a synthesized output pitch waveform.

12. A system as in claim 11, wherein the analysis window size (α) and the synthesis window size (β) are related according to the expression β=α/1+r=100/1+r where r is a speech rate change.

13. A system as in claim 9, further comprising a binaural filter coupled between each PSS synthesizer and the priority queue.

14. A system as in claim 14, further comprising a signal duration analyzer coupled to the input of each PSS analyzer.

15. A system as in claim 9, wherein the playback device is a headphone.
